(19) United States
(12) Patent Application Publication
(10) Pub. No.: US 2002/0076648 A1
(43) Pub. Date: Jun. 20, 2002

(54) Optical data medium containing, in the information layer, a phthalocyanine dye as a light-absorbing compound

(76) Inventors: Horst Berneth, Leverkusen (DE); Karl-Friedrich Bruder, Krefeld (DE); Wilfried Haese, Odenthal (DE); Karin Hassenruck, Dusseldorf (DE); Serguei Kostromine, Swisttal (DE); Peter Landenberger, Koln (DE); Thomas Sommermann, Bergisch Gladbach (DE); Josef-Walter Stawitz, Odenthal (DE); Rainer Hagen, Leverkusen (DE); Rafael Oser, Krefeld (DE)

Correspondence Address: BAYER CORPORATION, PATENT DEPARTMENT, 100 BAYER ROAD, PITTSBURGH, PA, 15205, US

(21) Appl. No.: 09/960,625

(22) Filed: Sep. 20, 2001

(30) Foreign Application Priority Data
Sep. 21, 2000 (DE) 10046771.7
Mar. 28, 2001 (DE) 10115227.2
May 21, 2001 (DE) 10124585.8
Aug. 22, 2001 (DE) 10140165.5

(51) Int. Cl. G11B 7/24; C09B 47/04

(52) U.S. Cl. 430/270.17; 540/128

(57) ABSTRACT

The invention relates to an optical data medium containing a preferably transparent substrate that is optionally already coated with one or more reflective layers and on the surface of which have been applied:

(1) an information layer that can be recorded on using light, wherein the information layer contains at least one phthalocyanine light-absorbing compound and optionally a binder,

(2) optionally one or more reflective layers, and

(3) optionally a protective layer or a further substrate or a covering layer

wherein the optical data medium can be recorded on and read using blue light, preferably laser light.

### BACKGROUND OF THE INVENTION

The invention relates to a singly recordable optical data medium that contains, in the information layer, at least one phthalocyanine dye as a light-absorbing compound, and a process for its production.

The singly recordable optical data media using special light-absorbing substances or mixtures thereof are suitable in particular for use in the case of high-density recordable optical data media which operate with blue laser diodes, in particular GaN or SHG laser diodes (360 to 460 nm) and/or for use in the case of DVD-R or CD-R discs that operate with red (635 to 660 nm) or infrared (780 to 830 nm) laser diodes, and the application of the above-mentioned dyes to a polymer substrate, particularly polycarbonate, by spin-coating, vapor deposition or sputtering.

The singly recordable compact disc (CD-R, 780 nm) has recently been experiencing enormous growth in quantity and is a technically established system.

Recently, the next generation of optical data stores—the DVD—was launched on the market. By using shorter-wave laser radiation (635 to 660 nm) and a higher numerical aperture NA, the storage density can be increased. In this case, the singly recordable format is the DVD-R.

Optical data storage formats that use blue laser diodes (based on GaN, JP-A 08/191,171 or Second Harmonic Generation SHG JP-A 09/050,629) (360 nm to 460 nm) having a high laser power are now being developed. Recordable optical data stores are therefore also used in this generation. The recordable storage density depends on the focusing of the laser spot in the information plane. The spot size is scaled with the laser wavelength λ/NA. NA is the numerical aperture of the lens used. In order to obtain as high a storage density as possible, the use of as short a wavelength λ as possible is desirable. At present, a wavelength of 390 nm is possible on the basis of semiconductor laser diodes.

The patent literature describes recordable optical data stores that are based on dyes and are just as suitable for CD-R and DVD-R systems (JP-A 11/043,481 and JP-A 10/181,206). Here, for high reflectivity and a high modulation amplitude of the read-out signal, and for sufficient sensitivity during recording, use is made of the fact that the IR wavelength 780 nm of the CD-R lies at the foot of the long-wave flank of the absorption peak of the dye, and the red wavelength 635 nm or 650 nm of the DVD-R lies at the foot of the short-wave flank of the absorption peak of the dye (cf. EP-A 519,395 and WO-A 00/09522). This concept is extended in JP-A 02/557,335, JP-A 10/058,828, JP-A 06/336,086, JP-A 02/865,955, WO-A 09/917,284 and U.S. Pat. No. 5,266,699 to include the region of 450 nm operating wavelength on the short-wave flank and the red and IR region on the long-wave flank of the absorption peak.

In addition to the above-mentioned optical properties, the recordable information layer comprising light-absorbing organic substances must have a morphology that is as amorphous as possible in order to minimize the noise signal during recording and read-out. For this purpose, it is particularly preferred if, during application of the substances by spin-coating from a solution, by sputtering, or by vapor deposition and/or sublimation, crystallization of the light-absorbing substances is prevented during the subsequent overcoating with metallic or dielectric layers in vacuo.

The amorphous layer of light-absorbing substances should preferably have a high heat distortion resistance, since otherwise further layers of organic or inorganic material that are applied by sputtering or vapor deposition to the light-absorbing information layer will form ill-defined interfaces through diffusion and thus adversely affect the reflectivity. In addition, light-absorbing substances having too low a heat distortion resistance at the interface with a polymeric substrate can diffuse into the latter and once again adversely affect the reflectivity.

If a light-absorbing substance has too high a vapor pressure, the substance can sublime during the above-mentioned sputtering or vapor deposition of further layers in a high vacuum and hence reduce the desired layer thickness. This in turn leads to an adverse effect on the reflectivity.

It is accordingly an object of the invention to provide suitable compounds that meet the high requirements (such as light stability, advantageous signal/noise ratio, damage-free application to the substrate material, etc.) for use in the information layer in a singly recordable optical data medium, particularly for high-density recordable optical data storage formats in a laser wavelength range of from 360 to 460 nm.

Surprisingly, it was found that light-absorbing compounds from the group consisting of the phthalocyanines can fulfil the above-mentioned requirement profile particularly well. Phthalocyanines have an intense absorption in the wavelength range of 360 to 460 nm important for the laser, i.e., the B or Soret band.

### SUMMARY OF THE INVENTION

The present invention therefore relates to an optical data medium, comprising a substrate (preferably a transparent substrate) that is optionally already coated with one or more reflective layers and on the surface of which have been applied:

(1) an information layer that can be recorded on using light, wherein the information layer contains (i) a light-absorbing compound comprising at least one phthalocyanine and (ii) optionally a binder,

(2) optionally one or more reflective layers, and

(3) optionally a protective layer or a further substrate or a covering layer,

wherein the optical data medium can be recorded on and read using blue light (preferably laser light, particularly preferably light at 360 to 460 nm, particularly 380 to 420 nm, very particularly preferably at 390 to 410 nm).

### DETAILED DESCRIPTION OF THE INVENTION

In a preferred embodiment, the phthalocyanine used is a compound of the formula (I)

MPc[R³]_{w}[R⁴]ₓ[R⁵]_{y}[R⁶]_{z} (I),

in which

Pc represents a phthalocyanine,

M represents two independent H atoms, a divalent metal atom, a trivalent axially monosubstituted metal atom of the formula (Ia)

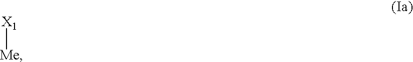

a tetravalent axially disubstituted metal atom of the formula (Ib)

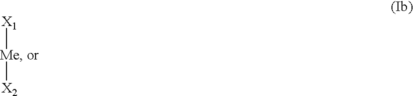

a trivalent axially monosubstituted and axially monocoordinated metal atom of the formula (Ic)

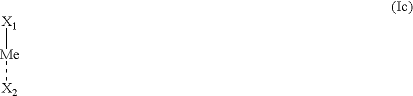

with the proviso that when X₁ or X₂ is a charged ligand, the charge is compensated by an oppositely charged ion (for example, an anion An⁻ or cation Kat^{⊕}), in which

X¹ and X², independently of one another, represent halogen (i.e., F, Cl, Br, or I), hydroxyl, oxygen, cyano, thiocyanato, cyanato, alkenyl, alkinyl, arylthio, dialkylamino, alkyl, alkoxy, acyloxy, alkylthio, aryl, aryloxy, —O—SO₂R⁸, —O—PR¹⁰R¹¹, —O—P(O)R¹²R¹³, —O—SiR¹⁴R¹⁵R¹⁶, NH₂, alkylamino, and the radical of a heterocyclic amine,

R³, R⁴, R⁵ and R⁶ correspond to substituents of the phthalocyanine ring and, independently of one another, represent halogen (i.e., F, Cl, Br, or I), cyano, nitro, alkyl, aryl, alkylamino, dialkylamino, alkoxy, alkylthio, aryloxy, arylthio, SO₃H, SO₂NR¹R², CO₂R⁹, CONR¹R², NH—COR⁷, or a radical of the formula -(B)ₘ-D in which

B denotes a bridge member from the group consisting of a direct bond, CH₂, CO, CH(alkyl), C(alkyl)₂, NH, S, O, or —CH═CH—, such that (B)ₘ denotes a chemically reasonable sequence of bridge members B in which m is from 1 to 10 (preferably m is 1, 2, 3 or 4), and

D represents the monovalent radical of a redox system of the formula

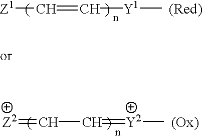

or represents a metallocenyl radical or metallocenylcarbonyl radical, in which titanium, manganese, iron, ruthenium, or osmium is suitable as the metal center, wherein

Z¹ and Z², independently of one another, represent NR′R″, OR″, or SR″,

Y¹ represents NR′, O, or S,

Y² represents NR′,

n represents 1 to 10, and

R′ and R″, independently of one another, represent hydrogen, alkyl, cycloalkyl, aryl, or hetaryl, or form a direct bond or bridge to one of the C atoms of the

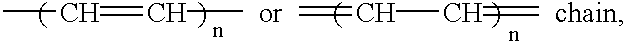

w, x, y and z, independently of one another, represent 0 to 4 and the sum

w+x+y+z is≦16,

R¹ and R², independently of one another, represent hydrogen, alkyl, hydroxyalkyl, or aryl, or R¹ and R², together with the N atom to which they are bonded, form a heterocyclic 5-, 6-, or 7-membered ring, optionally with participation of further hetero atoms (particularly from the group consisting of O, N and S), where NR¹R² particularly represents pyrrolidino, piperidino, or morpholino,

R⁷ to R¹⁶, independently of one another, represent alkyl, aryl, hetaryl, or hydrogen (particularly alkyl, aryl, or hetaryl),

An⁻ represents an anion, in particular represents halide, C₁₋₂₀-alkyl-COO⁻, formate, oxalate, lactate, glycolate, citrate, CH₃OSO₃⁻, NH₂SO₃⁻, CH₃SO₃⁻, ½ SO₄²⁻, or ⅓ PO₄³⁻.

Where M represents a radical of the formula (Ic) (particularly with Co(III) as the metal atom), preferred heterocyclic amine ligands or substituents within the meaning of X¹ and X² are morpholine, piperidine, piperazine, pyridine, 2,2-bipyridine, 4,4-bipyridine, pyridazine, pyrimidine, pyrazine, imidazole, benzimidazole, isoxazole, benzisoxazole, oxazole, benzoxazole, thiazole, benzothiazole, quinoline, pyrrole, indole, and 3,3-dimethylindole, each of which is coordinated with or substituted by the metal atom at the nitrogen atom.

The alkyl, alkoxy, aryl, and heterocyclic radicals can optionally carry further radicals, such as alkyl, halogen, hydroxyl, hydroxyalkyl, amino, alkylamino, dialkylamino, nitro, cyano, CO—NH₂, alkoxy, alkoxycarbonyl, morpholino, piperidino, pyrrolidino, pyrrolidono, trialkylsilyl, trialkylsiloxy, or phenyl. The alkyl and alkoxy radicals may be saturated, unsaturated, straight-chain, or branched, the alkyl radical may be partly halogenated or perhalogenated, and the alkyl and alkoxy radical may be ethoxylated, propoxylated, or silylated. Neighboring alkyl and/or alkoxy radicals on aryl or heterocyclic radicals may together form a three- or four-membered bridge.

Preferred compounds of the formula (I) are those in which the following applies for the radical R¹ to R¹⁶, R′ and R″ and for the ligands or substituents X¹ and X²:

substituents with the designation “alkyl” preferably denote C₁-C₁₆-alkyl, particularly C₁-C₆-alkyl, that are optionally substituted by halogen (such as chlorine, bromine, or fluorine), hydroxyl, cyano, and/or C₁-C₆-alkoxy;

substituents with the designation “alkoxy” preferably denote C₁-C₁₆-alkoxy, particularly C₁-C₆-alkoxy, that are optionally substituted by halogen (such as chlorine, bromine, or fluorine), hydroxyl, cyano, and/or C₁-C₆-alkyl;

substituents with the designation “cycloalkyl” preferably denote C₄-C₈-cycloaklkyl, particularly C₅- to C₆-cycloalkyl, that are optionally substituted by halogen (such as chlorine, bromine, or fluorine), hydroxyl, cyano, and/or C₁-C₆-alkyl;

substituents with the designation “alkenyl” preferably denote C₆-C₈-alkenyl that are optionally substituted by halogen (such as chlorine, bromine, or fluorine), hydroxyl, cyano, and/or C₁-C₆-alkyl, with alkenyl particularly denoting allyl,

substituents with the meaning “hetaryl” preferably represent heterocyclic radicals having 5- to 7-membered rings that preferably contain hetero atoms from the group consisting of N, S, and/or O and are optionally fused with aromatic rings or optionally carry further substituents, such as halogen, hydroxyl, cyano, and/or alkyl, the following being particularly preferred: pyridyl, furyl, thienyl, oxazolyl, thiazolyl, imidazolyl, quinolyl, benzoxazolyl, benzothiazolyl, and benzimidazolyl,

the substituents with the designation “aryl” are preferably C₆-C₁₀-aryl, particularly phenyl or naphthyl, that are optionally substituted by halogen (such as F or Cl), hydroxyl, C₁-C₆-alkyl, C₁-C₆-alkoxy, NO₂, and/or CN.

R³, R⁴, R⁵ and R⁶, independently of one another preferably represent chlorine, fluorine, bromine, iodine, cyano, methyl, ethyl, propyl, isopropyl, butyl, isobutyl, tert-butyl, pentyl, tert-amyl, hydroxyethyl, 3-dimethylaminopropyl, 3-diethylaminopropyl, phenyl, p-tert-butylphenyl, p-methoxyphenyl, isopropylphenyl, trifluoromethylphenyl, naphthyl, methylamino, ethylamino, propylamino, isopropylamino, butylamino, isobutylamino, tert-butylamino, pentylamino, tert-amylamino, benzylamino, methylphenylhexylamino, hydroxyethylamino, aminopropylamino, aminoethylamino, 3-dimethylaminopropylamino, 3-diethylaminopropylamino, diethylaminoethylamino, dibutylaminopropylamino, morpholinopropylamino, piperidinopropylamino, pyrrolidinopropylamino, pyrrolidonopropylamino, 3-(methylhydroxyethylamino)propylamino, methoxyethylamino, ethoxyethylamino, methoxypropylamino, ethoxypropylamino, methoxyethoxypropylamino ethoxypropylamino, 3-(2-ethylhexyloxy)propylamino, isopropyloxypropylamino, dimethylamino, diethylamino, diethanolamino, dipropylamino, diisopropylamino, dibutylamino, diisobutylamino, di-tert-butylamino, dipentylamino, di-tert-amylamino, bis(2-ethylhexyl)amino, bis(aminopropyl) amino, bis(aminoethyl)amino, bis(3-dimethylaminopropyl)amino, bis(3-diethylaminopropyl)amino, bis(diethylaminoethyl)amino, bis(dibutylaminopropyl) amino, di(morpholinopropyl)amino, di(piperidinopropyl)amino, di(pyrrolidinopropyl)amino, di(pyrrolidonopropyl)amino, bis(3-(methylhydroxyethylamino) propyl)amino, dimethoxyethylamino, diethoxyethylamino, dimethoxypropylamino, diethoxypropylamino, di(methoxyethoxyethyl) amino, di(methoxyethoxypropyl)amino, bis(3-(2-ethylhexyloxy)propyl) amino, di(isopropyloxyisopropyl)amino, methoxy, ethoxy, propyloxy, isopropyloxy, butyloxy, isobutyloxy, tert-butyloxy, pentyloxy, tert-amyloxy, methoxyethoxy, ethoxyethoxy, methoxypropyloxy, ethoxypropyloxy, methoxyethoxypropyloxy, 3-(2-ethylhexyloxy)propyloxy, methylthio, ethylthio, propylthio, isopropylthio, butylthio, isobutylthio, tert-butylthio, pentylthio, tert-amylthio, phenyl, methoxyphenyl, trifluoromethylphenyl, naphthyl, CO₂R⁷, CONR¹R², NH—COR⁷, SO₃H, SO₂NR¹R², or preferably represent a radical of the formula

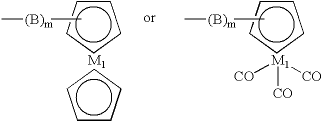

in which

(B)ₘ represents

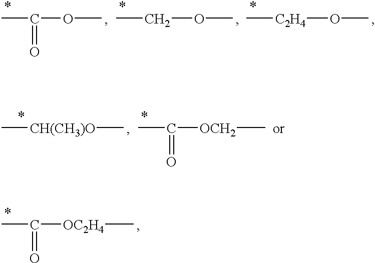

where the asterisk (*) indicates the link with the 5-membered ring,

M₁ represents an Mn or Fe cation,

w, x, y and z, independently of one another, represent 0 to 4 and w+x+y+z ≦12,

NR¹R² preferably represent amino, methylamino, ethylamino, propylamino, isopropylamino, butylamino, isobutylamino, tert. butylamino, pentylamino, tert amylamino, benzylamino, methylphenylhexylamino, 2-ethyl-1-hexylamino, hydroxyethylamino, aminopropylamino, aminoethylamino, 3-dimethylaminopropylamino, 3-diethylaminopropylamino, morpholinopropylamino, piperidinopropylamino, pyrrolidinopropylamino, pyrrolidonopropylamino, 3-(methyl-hydroxyethylamino) propylamino, methoxyethylamino, ethoxyethylamino, methoxypropylamino, ethoxypropylamino, methoxyethoxypropylamino, 3-(2-ethylhexyloxy)propylamino, isopropyloxyisopropylamino, dimethylamino, diethylamino, dipropylamino, diisopropylamino, dibutylamino, diisobutylamino, di-tert-butylamino, dipentylamino, di-tert-amylamino, bis(2-ethylhexyl)amino, dihydroxyethylamino, bis(aminopropyl)amino, bis(aminoethyl)amino, bis(3-dimethylaminopropyl) amino, bis(3-diethylaminopropyl)amino, di(morpholinopropyl)amino, di(piperidinopropyl)amino, di(pyrrolidinopropyl) amino, di(pyrrolidonopropyl)amino, bis(3-(methyl-hydroxyethylamino) propyl)amino, dimethoxyethylamino, diethoxyethylamino, dimethoxypropylamino, diethoxypropylamino, di(methoxyethoxypropyl) amino, bis(3-(2-ethylhexyloxy)propyl)amino, di(isopropyloxyisopropyl) amino, anilino, p-toluidino, p-tert-butylanilino, p-anisidino, isopropylanilino or naphtylamino or NR¹R² preferably represent pyrrolidino, piperidino, piperazino, or morpholino, and

R⁷ and R¹⁶, independently of one another preferably represent hydrogen, methyl, ethyl, propyl, isopropyl, butyl, isobutyl, tert-butyl, pentyl, tert-amyl, phenyl, p-tert-butylphenyl, p-methoxyphenyl, isopropylphenyl, p-trifluoromethylphenyl, cyanophenyl, naphthyl, 4-pyridyl, 2-pyridyl, 2-quinolinyl, 2-pyrrolyl, or 2-indolyl,

it being possible for the alkyl, alkoxy, aryl, and heterocyclic radicals optionally to carry further radicals, such as alkyl, halogen, hydroxyl, hydroxyalkyl, amino, alkylamino, dialkylamino, nitro, cyano, CO—NH₂, alkoxy, alkoxycarbonyl, morpholino, piperidino, pyrrolidino, pyrrolidono, trialkylsilyl, trialkylsilyloxy, or phenyl, for the alkyl and/or alkoxy radicals to be saturated, unsaturated, straight-chain, or branched, for the alkyl radicals to be partly halogenated or perhalogenated, for the alkyl and/or alkoxy radicals to be ethoxylated, propoxylated, or silylated, and for neighboring alkyl and/or alkoxy radicals on aryl or heterocyclic radicals together to form a three- or four-membered bridge.

In the context of this application, redox systems are understood as meaning in particular the redox systems described in Angew. Chem. 1978, page 927, and in Topics of Current Chemistry, Vol. 92, page 1 (1980). p-Phenylenediamines, phenothiazines, dihydrophenazines, bipyridinium salts (viologens), and quinodimethanes are preferred.

In a preferred embodiment, phthalocyanines of the formula (I) in which

M represents two independent H atoms or represents a divalent metal atom Me selected from the group consisting of Cu, Ni, Zn, Pd, Pt, Fe, Mn, Mg, Co, Ru, Ti, Be, Ca, Ba, Cd, Hg, Pb, and Sn, or

M represents a trivalent axially monosubstituted metal atom of the formula (Ia), in which the metal Me is selected from the group consisting of Al, Ga, Ti, In, Fe, and Mn, or

M denotes a tetravalent axially disubstituted metal atom of the formula (Ib), in which the metal Me is selected from the group consisting of Si, Ge, Sn, Zr, Cr, Ti, Co, and V, are used.

X¹ and X² are particularly preferably halogen (particularly chlorine), aryloxy (particularly phenoxy), or alkoxy (particular methoxy).

R³ to R⁶ particularly represent halogen, C₁-C₆-alkyl, or C₁-C₈-alkoxy.

Phthalocyanines of the formula (I) in which M represents a radical of the formula (Ia) or (Ib) and w, x, y, and z each represent 0, and X¹ and/or X² each denote halogen are very particularly preferred.

The phthalocyanines used according to the invention can be prepared by known methods, for example:

by synthesis of the nucleus from correspondingly substituted phthalodinitriles in the presence of the corresponding metals, metal halides, or metal oxides,

by chemical modification of a phthalocyanine, for example, by sulfochlorination or chlorination of phthalocyanines and further reactions, for example, condensations or substitutions of the products resulting therefrom,

the axial substituents X¹ and X² are usually prepared from the corresponding halides by exchange.

The light-absorbing compound should preferably be thermally modifiable. Thermal modification is preferably effected at a temperature of <600° C. Such a modification may be, for example, decomposition or chemical modification of the chromophoric center of the light-absorbing compound.

The light-absorbing substances described guarantee a sufficiently high reflectivity of the optical data medium in the unrecorded state and sufficiently high absorption for the thermal degradation of the information layer during illumination at a point with focused blue light (particularly laser light), preferably having a light wavelength in the range from 360 to 460 nm. The contrast between recorded and unrecorded parts on the data medium is realized through the change in reflectivity in terms of the amplitude as well as the phase of the incident light as a result of the changed optical properties of the information layer after the thermal degradation. In other words, the optical data medium can preferably be recorded on and read using laser light having a wavelength of 360 to 460 nm.

Coating with the phthalocyanines is preferably effected by spin-coating, sputtering or vacuum vapor deposition. By vacuum vapor deposition or sputtering, it is possible to apply in particular the phthalocyanines that are insoluble in organic or aqueous media, preferably those of the formula (I) in which w, x, y, and z each denote 0 and M represents

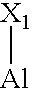

or represents

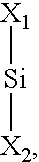

in which X₁ and X₂ have the above-mentioned meaning.

In particular, the phthalocyanines that are soluble in organic or aqueous media are suitable for application by spin-coating. The phthalocyanines cyanines can be mixed with one another or with other dyes having similar spectral properties. The information layer may contain additives, such as binders, wetting agents, stabilizers, diluents and sensitizers, and further components in addition to the phthalocyanines.

The optical data store may carry further layers, such as metal layers, dielectric layers, and protective layers, in addition to the information layer. Metal and dielectric layers serve, inter alia, for adjusting the reflectivity and the heat balance. Metals may be gold, silver, aluminum, various alloys, etc., depending on the laser wavelength. Dielectric layers are, for example, silica and silicon nitride. Protective layers are, for example, photocurable coats, adhesive layers, and protective films.

Alternatively, the structure of the optical data medium can

contain a preferably transparent substrate on the surface of which at least one information layer that can be recorded on using light, optionally a reflective layer, and optionally an adhesive layer and a further preferably transparent substrate have been applied.

contain a preferably transparent substrate on the surface of which optionally a reflective layer, at least one information layer that can be recorded on using light, optionally an adhesive layer, and a transparent covering layer have been applied.

Examples of such structures are illustrated below:

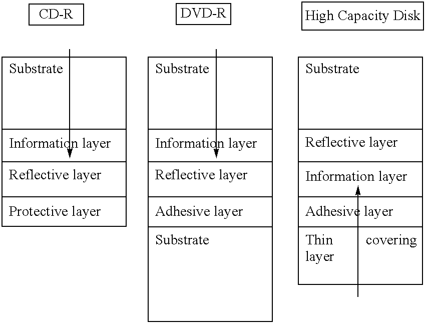

The invention furthermore relates to optical data media according to the invention which can be recorded on using blue light, particularly laser light, particularly preferably laser light having a wavelength of 360 to 460 nm.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all percentages are percentages by weight.

### EXAMPLES

### Example 1

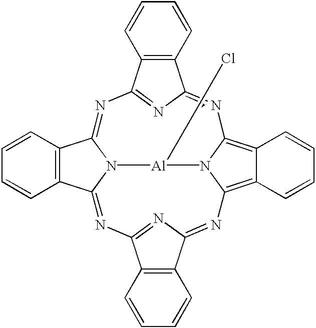

The dye monochloro-aluminum-phthalocyanine (AICIPc) was applied by vapor deposition in a high vacuum (pressure p≈2·10⁻⁵ mbar) from a resistively heated molybdenum boat at a rate of about 5 Å/s on a pregrooved polycarbonate substrate. The layer thickness was about 70 nm. The pregrooved polycarbonate substrate was produced as a disc by injection moulding. The diameter of the disc was 120 mm and its thickness 0.6 mm. The grooved structure applied in the injection molding process had a track spacing of about 1 μm, and the groove depth and groove half-width were about 150 nm and about 260 nm, respectively. The disc with the dye layer as information carrier was coated with 100 nm of Ag with vapor deposition. Thereafter, a UV-curable acrylic coat was applied by spin-coating and cured using a UV lamp. Testing was carried out using a dynamic recording test setup that was mounted on an optical bench, consisting of a GaN diode laser (λ=405 nm), for producing linearly polarized laser light, a polarization-sensitive beam splitter, a λ/4 plate, and a movably suspended collecting lens having a numerical aperture NA of 0.65 (actuator lens). The light reflected by the disc was coupled out of the beam path with the aid of the above-mentioned polarization-sensitive beam splitter and focused by an astigmatic lens onto a four-quadrant detector. At a linear velocity V of 5.24 m/s and the write power P_{w} of 13 mW, a signal/noise ratio S/N of 25 dB was measured. The write power was applied here as a pulse sequence, the disc being irradiated alternately for 1 μs with the above-mentioned write power P_{w} and for 4 μs with the read power Pᵣ of 0.44 mW. The disc was irradiated with this pulse sequence until it had completed one revolution. The marks thus produced were then read out with the read power Pᵣ of 0.44 mW and the above-mentioned signal/noise ratio S/N was measured.

### Example 2

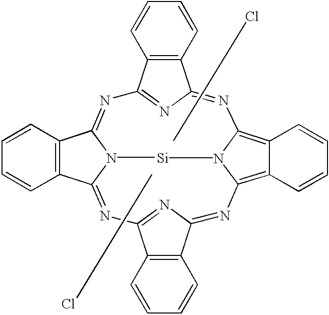

A 45 nm thick layer of the dye dichloro-silicon-phthalocyanine was applied by vapor deposition analogously to Example 1 to a disc having the same thickness and groove structure. Using the same optical setup and the same recording strategy (write power P_{w} of 13 mW, read power Pᵣ of 0.44 mW), a signal/noise ratio S/N of 46 dB was measured at a linear velocity V of 4.19 m/s.

The phthalocyanines of the following Examples were also used analogously to the procedure of Examples 1 and 2 and showed comparable properties.

### Example 3

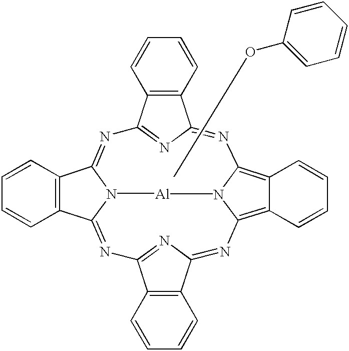

In each case a 70 nm thick layer of the dye phenoxy-aluminum-phthalocyanine was applied by vapor deposition analogously to Example 1 to a disc having the same thickness and groove structure. Using the same optical setup and the same recording strategy (write power P_{w} of 13 mW, read power Pᵣ of 0.44 mW) as in Example 1, a signal/noise ratio S/N of 22 dB was measured at a linear velocity V of 5.24 m/s.

### Example 4

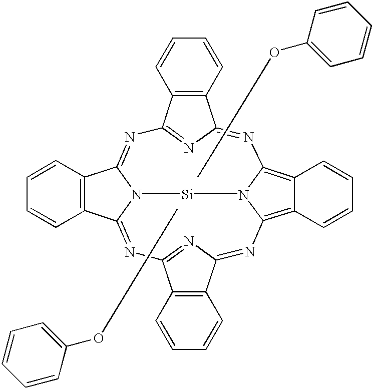

In each case a 70 nm thick layer of the dye diphenoxy-silicon-phthalocyanine was applied by vapor deposition analogously to Example 1 to a disc having the same thickness and groove structure. Using the same optical setup and the same recording strategy (write power P_{w} of 13 mW, read power Pᵣ of 0.44 mW) as in Example 1, the signal/noise ratio S/N of 23 dB was measured at a linear velocity V of 5.24 m/s.

### Example 5

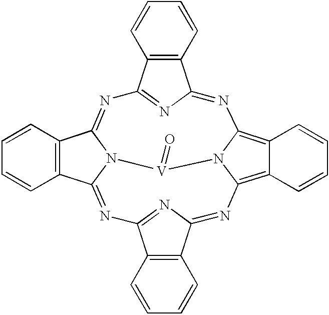

What is claimed is:

1. An optical data medium comprising a substrate that is optionally already coated with one or more reflective layers and on the surface of which have been applied
(1) an information layer that can be recorded on using light, wherein the information layer contains (i) a light-absorbing compound comprising at least one phthalocyanine and (ii) optionally a binder,
(2) optionally one or more reflective layers, and
(3) optionally a protective layer or a further substrate or a covering layer,
wherein the optical data medium can be recorded on and read using blue light.

2. An optical data medium according to claim 1 wherein the substrate is transparent.

3. An optical data medium according to claim 1 wherein the blue light is provided by a laser light.

4. An optical data medium according to claim 1 wherein the phthalocyanine dye corresponds to the formula (I)
MPc[R³]_{w}[R⁴]ₓ[R⁵]_{y}[R⁶]_{z} (I),
in which
Pc represents a phthalocyanine,
M represents two independent H atoms, a divalent metal atom, a trivalent axially monosubstituted metal atom of the formula (Ia) 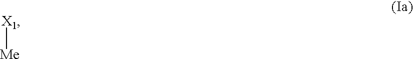
a tetravalent axially disubstituted metal atom of the formula (Ib) 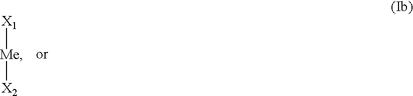
a trivalent axially monosubstituted and axially monocoordinated metal atom of the formula (Ic) 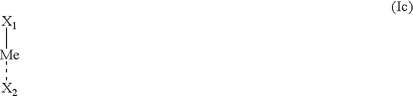
with the proviso that when X₁ or X₂ is a charged ligand, the charge is compensated by an oppositely charged ion, in which
X¹ and X², independently of one another, represent halogen, hydroxyl, oxygen, cyano, thiocyanato, cyanato, alkenyl, alkinyl, arylthio, dialkylamino, alkyl, alkoxy, acyloxy, alkylthio, aryl, aryloxy, —O—SO₂R⁸, O—PR¹⁰R¹¹, —O—P(O)R¹²R¹³, —O—SiR¹⁴R¹⁵R¹⁶, NH₂, alkylamino and the radical of a heterocyclic amine,
R³, R⁴, R⁵ and R⁶ correspond to substituents of the phthalocyanine and independently of one another, represent halogen, cyano, nitro, alkyl, aryl, alkylamino, dialkylamino, alkoxy, alkylthio, aryloxy, arylthio, SO₃H, SO₂NR¹R², CO₂R⁹, CONR¹R², NH—COR⁷, or a radical of the formula -(B)ₘ-D, in which
B denotes a bridge member selected from the group consisting of a direct bond, CH₂, CO, CH(alkyl), C(alkyl)₂, NH, S, O, or —CH═CH—, such that (B)ₘ denotes a chemically reasonable sequence of bridge members B with m=1 to 10, and
D represents the monovalent radical of a redox system of the formula 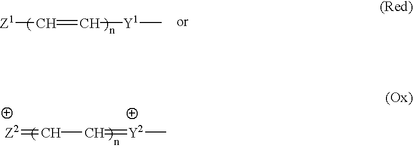
or represents a metallocenyl radical or metallocenylcarbonyl radical, wherein Z¹ and Z², independently of one another, represent NR′R″, OR″, or SR″,
Y¹ represents NR′, O, or S,
Y² represents NR′,
n represents 1 to 10, and
R′ and R″, independently of one another, represent hydrogen, alkyl, cycloalkyl, aryl or hetaryl, or form a direct bond or a bridge to one of the C atoms of the 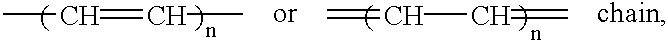
w, x, y and z, independently of one another, represent 0 to 4 and the sum w+x+y+z is ≦16,
R¹ and R², independently of one another, represent hydrogen, alkyl, hydroxyalkyl, or aryl, or R¹ and R², together with the N atom to which they are bonded, form a heterocyclic 5-, 6-, or 7-membered ring, optionally with participation of further hetero atoms, and
R⁷ and R¹⁶, independently of one another, represent alkyl, aryl, hetaryl, or hydrogen.

5. An optical data medium according to claim 4 wherein M represents
(1) two independent H atoms or a divalent metal atom selected from the group consisting of Cu, Ni, Zn, Pd, Pt, Fe, Mn, Mg, Co, Ru, Ti, Be, Ca, Ba, Cd, Hg, Pb, and Sn,
(2) a trivalent axially monosubstituted metal atom of the formula (Ia) in which Me represents Al, Ga, Ti, In, Fe, or Mn, or
(3) a tetravalent metal atom of the formula (Ib) in which Me represents Si, Ge, Sn, Zn, Cr, Ti, Co, or V.

6. An optical data medium according to claim 4 wherein M represents a radical of the Formula (Ia) in which Me represents Al, X₁ and X₂ represent halogen, aryloxy, or alkoxy, and w, x, y, and z each represent 0.

7. An optical data medium according to claim 4 wherein M represents a radical of the Formula (Ib) in which Me represents Si, X₁ and X₂ represent halogen, aryloxy, or alkoxy, and w, x, y, and z each represent 0.

8. A process for the production of the optical data medium according to claim 1 comprising coating a substrate that is optionally already coated with a reflective layer with a phthalocyanine dye, optionally in combination with suitable binders and additives and optionally suitable solvents, and optionally providing the substrate with a reflective layer, further intermediate layers, and optionally a protective layer or a further substrate or a covering layer.

9. A process for the production of the optical data media according to claim 8 wherein the coating with the phthalocyanine dye is effected by spin-coating, sputtering, or vapor deposition.

10. An optical data medium having a recordable information layer, wherein the optical data medium is obtained by recording on an optical data medium according to claim 1 using blue light.

11. An optical data medium having a recordable information layer, wherein the optical data medium is obtained by recording on an optical data medium according to claim 1 using a laser light having a wavelength of 360 to 460 nm.
